(19) United States
(12) Patent Application Publication
(10) Pub. No.: US 2024/0372164 A1
(43) Pub. Date: Nov. 7, 2024

(54) Method and System for Manufacturing Battery Cell

(71) Applicant: LG Energy Solution, Ltd., Seoul (KR)

(72) Inventors: Wi Dae Park, Daejeon (KR); Tae Kwang Jung, Daejeon (KR); Seol Hee Kim, Daejeon (KR); Min Su Kim, Daejeon (KR); Dong Wook Park, Daejeon (KR); Dong Min Seo, Daejeon (KR)

(73) Assignee: LG Energy Solution, Ltd., Seoul (KR)

(21) Appl. No.: 18/287,941

(22) PCT Filed: Mar. 31, 2022
(86) PCT No.: PCT/KR2022/004607

§ 371 Date: Oct. 23, 2023

(30) Foreign Application Priority Data
May 7, 2021 (KR) 10-2021-0059566
Mar. 25, 2022 (KR) 10-2022-0037670

(51) Int. Cl. H01M 10/48; G01B 11/06; H01M 10/04; H01M 50/105

(52) U.S. Cl. CPC H01M 10/48; G01B 11/06; H01M 10/0404; H01M 50/105

(57) ABSTRACT

A method for manufacturing a battery cell according to an embodiment of the present invention includes: a sealing process of forming a sealing part on the battery cell having an electrode assembly accommodated in a pouch; a transfer process of transferring the battery cell to position the sealing part between a first confocal-sensor and a second confocal-sensor, which are disposed to face each other; and a measurement process of measuring a thickness of the sealing part with the first confocal-sensor and the second confocal-sensor.

### CROSS-REFERENCE TO RELATED APPLICATION

The present application is a national phase entry under 35 U.S. C. § 371 of International Application No. PCT/KR2022/004607, filed Mar. 31, 2022, which claims the benefit of the priority of Korean Patent Application Nos. 10-2021-0059566, filed on May 7, 2021, and 10-2022-0037670, filed on Mar. 25, 2022, which are hereby incorporated by reference in their entirety.

### TECHNICAL FIELD

The present invention relates to a method and system for manufacturing a battery cell, and more particularly, to a method and system for manufacturing a pouch-type battery cell.

### BACKGROUND ART

In general, secondary batteries include nickel-cadmium batteries, nickel-hydrogen batteries, lithium ion batteries, and lithium ion polymer batteries. Such a secondary battery is being applied to be used in small-sized products such as digital cameras, P-DVDs, MP3Ps, mobile phones, PDAs, portable game devices, power tools, E-bikes, and the like as well as large-sized products requiring high power such as electric vehicles and hybrid vehicles, power storage devices for storing surplus power or renewable energy, and backup power storage devices.

In general, in order to manufacture the secondary battery, first, electrode active material slurry is applied to a positive electrode collector and a negative electrode collector to manufacture a positive electrode and a negative electrode. Then, the electrodes are stacked on both sides of a separator to form an electrode assembly. Also, the electrode assembly is accommodated in a battery case, and then the battery case is sealed after an electrolyte is injected therein.

The secondary battery may be classified into a pouch-type battery cell and a can-type battery cell according to a material of the case accommodating the electrode assembly.

Particularly, in the pouch-type battery cell (hereinafter, referred to as a battery cell), an electrode assembly and an electrolyte are accommodated in a pouch.

In addition, it is common to inspect a thickness of a sealing part of the battery cell as one of the quality evaluations of the battery cell. The sealing part means a portion in which portions facing each other in the pouch are bonded to each other by welding.

However, in the related art, an operator manually inspected the thickness of the sealing part using a micrometer or the like. Thus, there is a problem that the total inspection is impossible, and accuracy and reliability in thickness measurement are diminished.

### DISCLOSURE OF THE INVENTION

### Technical Problem

An object achieved by the present invention is to provide a method and system for manufacturing a battery cell, which are capable of performing total inspection by automatically inspecting a thickness of a sealing part of the battery cell.

Another object achieved by the present invention is to provide a method and system for manufacturing a battery cell, in which accuracy and reliability of measuring a thickness of a sealing part of the battery cell are improved.

### Technical Solution

A method for manufacturing a battery cell according to an embodiment of the present invention includes: a sealing process of forming a sealing part on a battery cell, in which an electrode assembly is accommodated in a pouch; a transfer process of transferring the battery cell to locate the sealing part between a first confocal-sensor and a second confocal-sensor, which are disposed to face each other; and a measurement process of measuring a thickness of the sealing part through the first confocal-sensor and the second confocal-sensor.

The method may further include a fixing process of fixing the sealing part in an unfolded state, which is performed between the transfer process and the measurement process.

In the measurement process, the first confocal-sensor and the second confocal-sensor may continuously or discontinuously measure the thickness of the sealing part while moving in a longitudinal direction of the sealing part.

In the measurement process, the first confocal-sensor and the second confocal-sensor may sequentially measure thicknesses at a plurality of points different from each other while moving in a longitudinal direction of the sealing part.

At least one of the plurality of points may be a position corresponding to an electrode lead.

Each of the first confocal-sensor and the second confocal-sensor may be provided in a pair to simultaneously measure thicknesses of a pair of sealing parts disposed at sides opposite to each other with the electrode assembly therebetween.

The method may further include a determination process of determining that one battery cell is defective when the thickness of the sealing part, which is measured in the measurement process, in the one battery cell is out of a critical range.

The critical range may be derived based on a plurality of pieces of thickness data collected through the measurement process for a sample group constituted by a plurality of battery cells.

A system for manufacturing a battery cell according to an embodiment of the present invention includes: a sealing unit configured to form a sealing part on a battery cell, in which an electrode assembly is accommodated in a pouch; a measurement unit including a first confocal-sensor and a second confocal-sensor, which are disposed to face each other; a transfer unit configured to transfer the battery cell so that the sealing part is disposed between the first confocal-sensor and the second confocal-sensor; and a controller configured to calculate a thickness of the sealing part based on a distance from the first confocal-sensor to one surface of the sealing part and a distance from the second confocal-sensor to the other surface of the sealing part.

The system may further include a discharge unit configured to discharge the battery cell, in which the thickness of the sealing part is completely measured, to a subsequent process line. The subsequent process line may include a process of injecting an electrolyte into the battery cell.

The measurement unit may further include a fixing member configured to fix the sealing part in an unfolded state.

An opening configured to reveal at least a portion of the sealing part with respect to the first confocal-sensor and the second confocal-sensor may be formed in the fixing member.

The measurement unit may further include a moving device configured to move the first confocal-sensor and the second confocal-sensor in parallel to a longitudinal direction of the sealing part. The first confocal-sensor and the second confocal-sensor may move by the moving device to continuously or discontinuously measure the thickness of the sealing part in the longitudinal direction of the sealing part.

The measurement unit may further include a fixing member configured to fix the sealing part in an unfolded state. At least one opening configured to reveal at least a portion of the sealing part with respect to the first confocal-sensor and the second confocal-sensor may be formed in the fixing member.

The measurement unit may further include a moving device configured to move the first confocal-sensor and the second confocal-sensor in parallel to a longitudinal direction of the sealing part. The first confocal-sensor and the second confocal-sensor may be moved by the moving device to sequentially measure thicknesses at a plurality of points different from each other in the longitudinal direction of the sealing part.

The measurement unit may further include a fixing member configured to fix the sealing part in an unfolded state. At least one opening configured to reveal a plurality of points with respect to the first confocal-sensor and the second confocal-sensor may be formed in the fixing member.

The system may further include a storage configured to store thickness data calculated in the controller. The controller may be configured to: derive a critical range based on a plurality of pieces of thickness data stored in the storage for a sample group constituted by a plurality of secondary batteries; and determine that one secondary battery is defective when the thickness of the sealing part is out of the critical range in the one secondary battery.

Each of the first confocal-sensor and the second confocal-sensor may be provided in a pair to measure thicknesses of a pair of sealing parts disposed at sides opposite to each other with the electrode assembly therebetween.

### Advantageous Effects

According to the preferred embodiment of the present invention, the thickness of the sealing part may be automatically inspected by the confocal-sensor. Therefore, there may be the advantage in that it is possible to totally inspect and automatically measure the sealing part of the battery cell. In addition, there may be the advantage in that the accuracy and reliability of measuring the thickness of the sealing part are improved.

In addition, since the thickness of the sealing part is measured in the state of being unfolded, the thickness of the sealing part in the longitudinal direction of the sealing part may be continuously or discontinuously measured to improve the accuracy and reliability of measuring the thickness of the sealing part.

In addition, since the thicknesses of the pair of sealing parts disposed opposite to each other with the electrode assembly therebetween are simultaneously measured, the time taken to perform the measurement process may be reduced.

### BRIEF DESCRIPTION OF THE DRAWINGS

FIG. 1 is an assembly view of a battery cell manufactured by a system for manufacturing a battery cell according to an embodiment of the present invention.

FIG. 2 is a schematic view illustrating the system for manufacturing the battery cell according to an embodiment of the present invention.

FIG. 3 is a control block diagram illustrating the system for manufacturing the battery cell according to an embodiment of the present invention.

FIG. 4 is a perspective view illustrating a measurement unit according to an embodiment of the present invention.

FIG. 5 is a plan view for explaining an operation of a fixing member according to an embodiment of the present invention.

FIG. 6 is a view for explaining operations of a first confocal-sensor and a second confocal-sensor according to an embodiment of the present invention.

FIG. 7 is a flowchart illustrating a method for manufacturing a battery cell according to an embodiment of the present invention.

FIG. 8 is a flowchart illustrating a method for manufacturing a battery cell according to another embodiment of the present invention.

### MODE FOR CARRYING OUT THE INVENTION

Hereinafter, preferred embodiments of the present invention will be described in detail with reference to the accompanying drawings so that those of ordinary skill in the art can easily carry out the present invention. However, the present invention may be implemented in several different forms and is not limited or restricted by the following examples.

In order to clearly explain the present invention, detailed descriptions of portions that are irrelevant to the description or related known technologies that may unnecessarily obscure the gist of the present invention have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

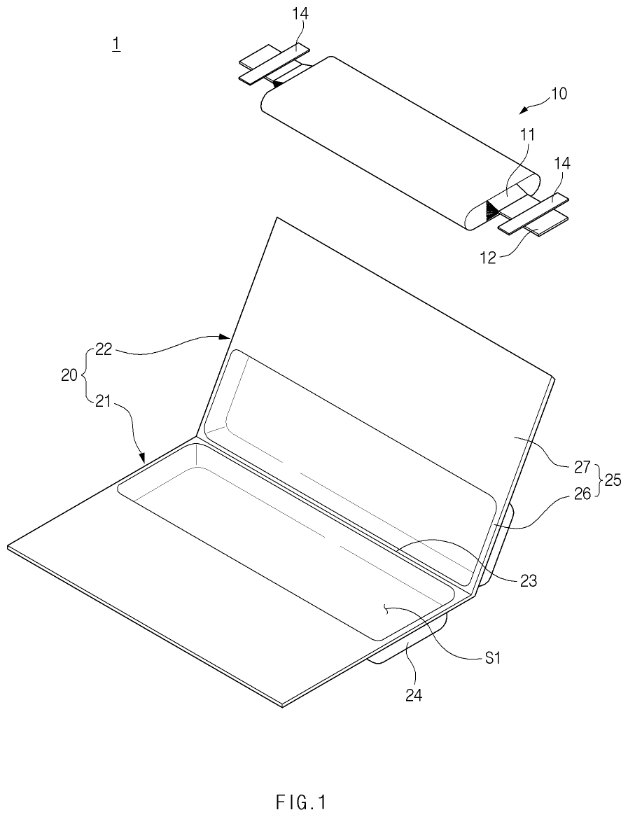

FIG. 1 is an assembly view of a battery cell manufactured by a system for manufacturing a battery cell according to an embodiment of the present invention.

A system for manufacturing a battery cell 1 (hereinafter, referred to as a ‘manufacturing system’) according to the present invention may manufacture a pouch-type battery cell 1.

In more detail, the battery cell 1 may include an electrode assembly 10, in which a positive electrode and a negative electrode are stacked with a separator therebetween, and a pouch 20 accommodating the electrode assembly 10.

The electrode assembly 10 may be provided with an electrode tab 11. The electrode tabs 11 are respectively connected to a positive electrode and a negative electrode of the electrode assembly 10 to protrude outward from the electrode assembly 10, thereby providing a path, through which electrons are moved, between the inside and outside of the electrode assembly 10.

The plurality of electrode tabs 11 connected to the positive electrode and the plurality of electrode tabs 11 connected to the negative electrode may protrude in different directions with respect to the electrode assembly 10. However, the present invention is not limited thereto, and the plurality of electrode tabs 11 connected to the positive electrode and the plurality of electrode tabs 11 connected to the negative electrode may protrude in parallel in the same direction with respect to the electrode assembly 10.

An electrode lead 12 supplying electricity to the outside of the battery cell 1 may be connected to the plurality of electrode tabs 11 by spot welding or the like. One end of the electrode lead 12 may be connected to the plurality of electrode tabs 11, and the other end of the electrode lead 12 may protrude to the outside of the pouch 20.

A portion of the electrode lead 12 may be surrounded by an insulating part 14. For example, the insulating part 14 may include an insulating tape. The insulating part 14 may be disposed between a pair of sides 26 of the pouch 20 to be described later, and in this state, the pair of sides 26 may be thermally fused to each other. In this case, a portion of the pair of sides 26 may be thermally fused to the insulating part 14. Thus, the insulating part 14 may prevent the electricity generated from the electrode assembly 10 from flowing to the pouch 20 through the electrode lead 12 and may maintain sealing of the pouch 20.

The pouch 20 may be formed by sealing a pair of cases 21 and 22 connected to each other by a folding part 23. A configuration of each case 21 and 22 to be described below will be described based on a state in which the pouch 20 is unfolded. The unfolded state of the pouch 20 means a state in which the pouch 20 is unfolded by releasing predetermined adhesion or sealing existing in the pouch 20.

Each of the cases 21 and 22 may include a cup part 24 having a recessed shape and a terrace 25 disposed around the cup part 24.

The cup part 24 may be recessed by a predetermined depth from the terrace 25 to form a recessed space S1.

The cup parts 24 of the pair of cases 21 and 22 may be connected to each other through the folding part 23. That is, the folding part 23 may be disposed between the pair of cup parts 24, and in a state in which the pouch 20 is unfolded, the folding part 23 may be referred to as a bridge. The folding part 23 may extend in parallel to a full-length direction of the pouch 20.

After the electrode assembly 10 is accommodated in a recessed space S1 of the cup part 24 formed in one case 21, the folding part 23 may be folded so that the cup part 24 formed in the other case 22 covers the electrode assembly 10.

That is, the recessed spaces S1 of the pair of cup parts 24 may communicate with each other, and the electrode assembly 10 may be accommodated in the pair of cup parts 24.

However, the configuration of the pouch 20 is not limited thereto, and a configuration in which the cup part 24 is formed only in one case 21, and the cup part 24 is not formed in the other case 22 is also possible. In this case, the electrode assembly 10 may be completely accommodated in the recessed space S1 of the cup part 24 formed in one case 21, and the other case 22 may cover the recessed space S1.

The terrace 25 may be disposed around an upper end of the cup part 24. In more detail, the terrace 25 may include an expansion part 27 disposed at an opposite side of the folding part 23 with respect to the cup part 24 and a pair of sides connecting the folding part 23 to the expansion part 27.

The pair of sides 26 extend in parallel to a full-width direction of the pouch 20 and may be disposed at sides opposite to each other with respect to the cup part 24. That is, the pair of sides 26 may be disposed at both sides of the cup part 24 in a front direction.

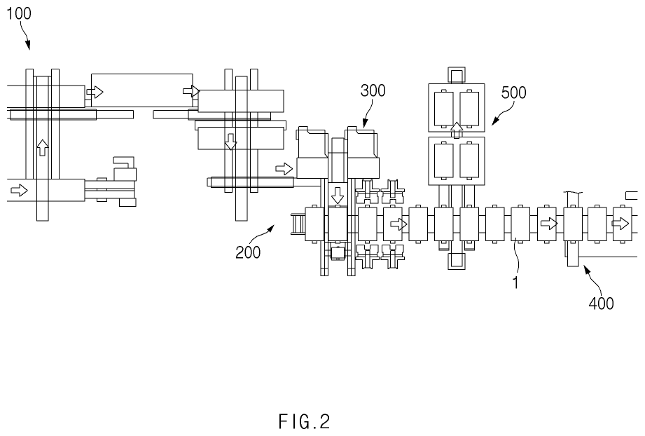

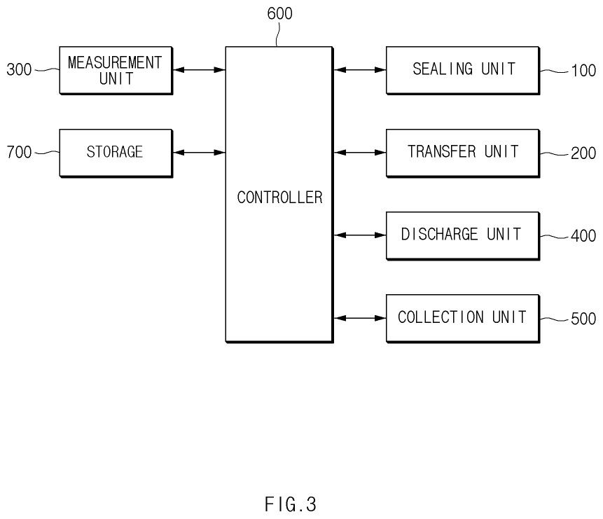

FIG. 2 is a schematic view illustrating the system for manufacturing the battery cell according to an embodiment of the present invention, and FIG. 3 is a control block diagram illustrating the system for manufacturing the battery cell according to an embodiment of the present invention.

The manufacturing system according to an embodiment of the present invention may include a sealing unit 100, a transfer unit 200, a measurement unit 300, and a discharge unit 400.

The sealing unit 100 may manufacture the battery cell 1 by sealing the pouch 20 in which the electrode assembly 10 is accommodated. In more detail, the sealing unit 100 may seal a portion of the terrace 25 in a state in which the folding part 23 of the pouch 20 is folded.

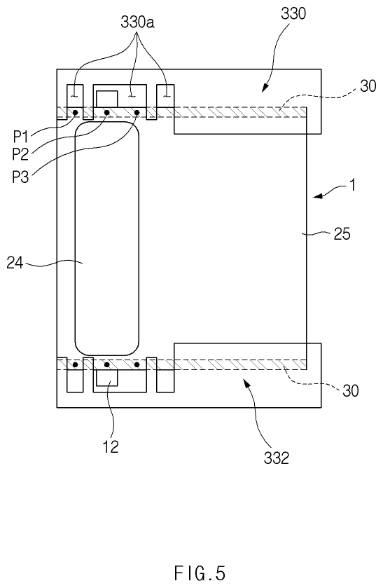

In more detail, the sealing part 30 (see FIG. 5) formed on the pouch 20 by the sealing unit 100 may be formed by fusing a terrace 25 of one case 21 and a terrace 25 of the other case 22 to each other.

The sealing part 30 may be formed on both edges of the battery cell 1 in a full-length direction. That is, a pair of sealing parts 30 spaced apart from each other with the cup part 24 therebetween may be formed.

Each of the sealing parts 30 may extend in the full-width direction of the battery cell 1. In more detail, one portion of each of the sealing parts 30 may be formed by fusing the pair of sides 26 to each other, and the other portion may be formed by fusing both sides of the pair of expansion parts 27 to each other.

In addition, in the expansion part 27, an edge extending in the full-length direction of the battery cell 1 may be in an unsealed state. Thus, an electrolyte may be injected into the battery cell 1 through a space between the pair of expansion parts 27 in a subsequent process. That is, the battery cell 1 manufactured in the sealing unit 100 may be in a state in which the electrolyte is not injected, and a portion of the expansion part 27 is not sealed.

The transfer unit 200 may transfer the battery cells 1 manufactured by the sealing unit 100 to the measurement unit 300. As an example, the transfer unit 200 may include a conveyor belt. However, the present invention is not limited thereto, and the configuration of the transfer unit 200 may be changed as needed.

The measurement unit 300 may measure a thickness of the sealing part 30 (see FIG. 5) formed on the pouch 20 by the sealing unit 100. The measurement unit 300 may measure a thickness of the sealing part 30 of all the battery cells 1 manufactured by the sealing unit 100. That is, the measurement unit 300 may perform a total inspection.

The measurement unit 300 may measure the thickness of the sealing part 30 in a state in which an operation of the transfer unit 200 is temporarily stopped.

A detailed configuration of the measurement unit 300 will be described later in detail.

The discharge unit 400 may discharge the battery cell 11 on which the measurement of the thickness of the sealing part 30 is completed in the measurement unit 300 to transfer the battery cell 11 to a subsequent process line. As an example, the discharge unit 400 may include a conveyor belt. However, the present invention is not limited thereto, and the configuration of the discharge unit 400 may be changed as needed.

In the subsequent process line, a process of injecting an electrolyte into the battery cell 1, a process of completely sealing an edge of the expansion part 27, an activation process of completing charging of the battery cell 1, and a degassing process of discharging a gas generated in the activation process from the battery cell may be performed. Since each of the processes is a known technique, detailed description thereof will be omitted.

That is, since the measurement of the thickness of the sealing part 30 of the battery cell 1 is performed before the injection of the electrolyte, the defective battery cell 1 is collected in advance in a collection unit 500 to be described later to prevent unnecessary consumption of the electrolyte.

The manufacturing system may further include the collection unit 500.

The collection unit 500 may collect the battery cells 1 inspected as defective by the measurement unit 300 so that the defective battery cells 1 are not discharged to the discharge unit 400. As an example, the collection unit 500 may include a robot arm that moves the battery cell 1 determined to be defective. However, the present invention is not limited thereto, and the configuration of the collection unit 500 may be changed as needed.

The manufacturing system may further include a controller 600 and a storage 700.

The controller 600 may include at least one processor. The controller 600 may control an overall operation of the manufacturing system. That is, the controller 600 may control the sealing unit 100, the transfer unit 200, the measurement unit 300, the discharge unit 400, and the collection unit 500. The configurations that are controllable by the controller 600 may be added, deleted, and changed as necessary.

The storage 700 may be a device capable of storing data. The controller 600 may store data in the storage 700 or recall data stored in the storage 700.

In more detail, the controller 600 may store thickness data of the sealing part 30 measured by the measurement unit 300 in the storage 700.

In addition, the controller 600 derives a critical range of the thickness of the sealing part 30 based on a plurality of pieces of thickness data collected in the storage 700 for a sample group constituted by the plurality of battery cells 1 to determine the battery cells 1, which are out of the critical range, as being defective. However, the present invention is not limited thereto, and it is also possible that the critical range is preset.

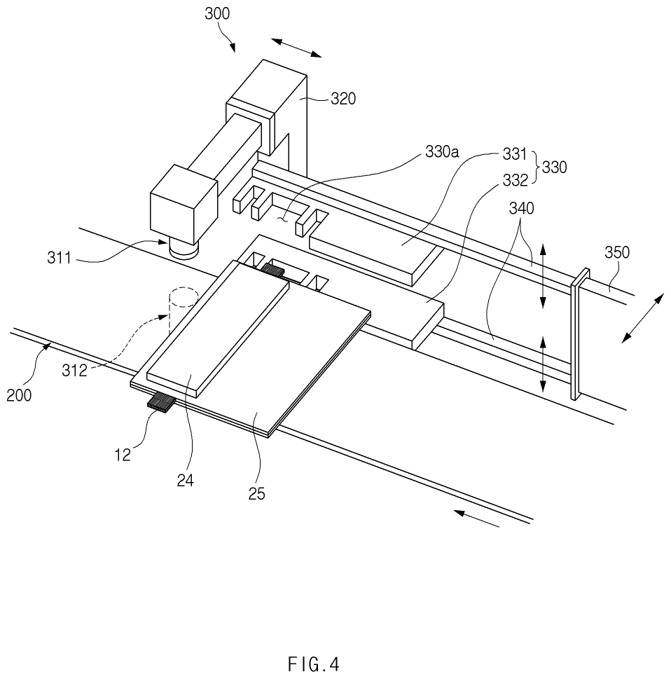

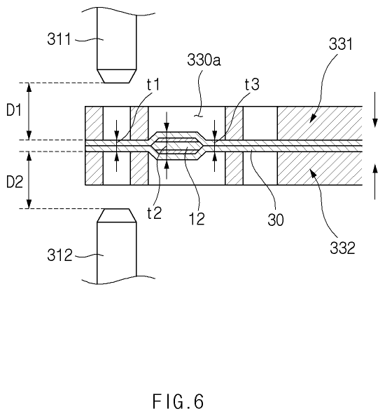

FIG. 4 is a perspective view illustrating the measurement unit according to an embodiment of the present invention, FIG. 5 is a plan view for explaining an operation of a fixing member according to an embodiment of the present invention, and FIG. 6 is a view for explaining operations of a first confocal-sensor and a second confocal-sensor according to an embodiment of the present invention.

The measurement unit 300 may include confocal-sensors 311 and 312 and a fixing member 330.

The confocal-sensors 311 and 312 are a kind of non-contact displacement measurement devices and are devices for precisely measuring displacement up to a specimen. Since the principle of each of the confocal-sensors 311 and 312 is a well-known technology, a detailed description thereof will be omitted.

The confocal-sensors 311 and 312 may include a first confocal-sensor 311 and a second confocal-sensor 312, which are disposed to face each other. In more detail, the first confocal-sensor 311 may be disposed above the second confocal-sensor 312, and the first confocal-sensor 311 and the second confocal-sensor 312 may be disposed to face each other in a vertical direction.

In a state in which the battery cell 1 is disposed in the measurement unit 300, the first confocal-sensor 311 may be disposed above the sealing part 30, and the second confocal-sensor 312 may be disposed below the sealing part 30. That is, the transfer unit 200 may transfer the battery cell 1 to locate the sealing part 30 between the first confocal-sensor 311 and the second confocal-sensor 312.

The first confocal-sensor 311 and the second confocal-sensor 312 may measure the thickness of the sealing part 30.

Each of the first confocal-sensor 311 and the second confocal-sensor 312 may be provided in a pair so as to be spaced apart from each other in the full-length direction of the battery cell 1 and may measure thicknesses of the pair of sealing parts 30 disposed at sides opposite to each other with the cup part 24 therebetween.

The first confocal-sensor 311 may measure a distance D1 (hereinafter, referred to as a ‘first distance’) up to one surface of the sealing part 30, in more detail, up to a top surface of the sealing part 30. In addition, the second confocal-sensor 313 may measure a distance D2 (hereinafter, referred to a ‘second distance’) up to the other surface of the sealing part 30, in more detail, up to a bottom surface. Also, the controller 600 may calculate the thickness of the sealing part 30 based on the first distance D1 and the second distance D2. Since the distance between the first confocal-sensor 311 and the second confocal-sensor 313 is preset or adjusted by the controller 600, a value obtained by subtracting the first distance D1 and the second distance D2 from a distance between the first confocal-sensor 311 and the second confocal-sensor 313 may be calculated as the thickness of the sealing part 30.

In more detail, the first confocal-sensor 311 and the second confocal-sensor 312 may measure a thickness of a portion of the sealing part 30, at which the pair of sides 26 (see FIG. 1) are fused, i.e., a portion of the sealing part 30, which is disposed on each of both sides of the cup part 24. This is because the portion at which the pair of expansion parts 27 are fused may be folded or cut out in the subsequent process.

The thickness of the sealing part 30 may vary along a longitudinal direction of the sealing part 30. The longitudinal direction of the sealing part 30 may be parallel to a transfer direction of the battery cell 1.

Thus, the first confocal-sensor 311 and the second confocal-sensor 312 may continuously or discontinuously measure the thickness of the sealing part 30 in the longitudinal direction of the sealing part 30.

In more detail, the first confocal-sensor 311 and the second confocal-sensor 312 may sequentially measure different thicknesses t1, t2, and t3 at a plurality of points P1, P2, and P3 in the longitudinal direction of the sealing part 30.

In more detail, the first confocal-sensor 311 and the second confocal-sensor may 312 sequentially measure thicknesses t1, t2, and t3 at a plurality of points P1, P2, and P3, which are gradually away from the folding part 23 of the pouch 20. Also, at least one of the plurality of points P1, P2, and P3 may be a position corresponding to the electrode lead 12.

For example, the first confocal-sensor 311 and the second confocal-sensor 312 may sequentially measure the thickness t1 at the first point P1, the thickness t2 at the second point P2, and the thickness t3 at the third point P3.

The first point P1 may be disposed at one side of the electrode lead 12, the second point P2 may be disposed on the electrode lead 12, and the third point P3 may be disposed at the other side of the electrode lead 13.

For this, the measurement unit 300 may further include a first moving device 320 that moves the first confocal-sensor 311 and the second confocal-sensor 312 in the longitudinal direction of the sealing part 30, i.e., in parallel to the full-width direction of the battery cell 1. The first moving device 320 may include an actuator (e.g., a motor) and may be connected to the first confocal-sensor 311.

The fixing member 330 may fix the sealing part 30 of the battery cell 1 in an unfolded state. In this state, the first confocal-sensor 311 and the second confocal-sensor 312 may measure the thickness of the sealing part 30. That is, the fixing member 330 may prevent the thickness of the sealing part 30 from being measured in a sagging or bent state to assist accurate measurement of the thickness of the sealing part 30.

The fixing member 330 may be provided in a pair, which are spaced apart from each other in the full-length direction of the battery cell 1 and may fix each of the pair of sealing parts 30 disposed at sides opposite to each other with the cup part 24 therebetween.

The fixing members 330 may include a first fixing member 331 and a second fixing member 332, which are disposed to face each other. In more detail, the first fixing member 331 may be disposed above the second fixing member 332, and the first fixing member 331 and the second fixing member 332 may be disposed to face each other in the vertical direction.

Each of the first fixing member 331 and the second fixing member 332 may have a plate or block shape that is disposed horizontally.

The first fixing member 331 and the second fixing member 332 may move in the full-length direction and the transfer direction of the battery cell 1.

In more detail, when the battery cell 1 is disposed in the measurement unit 300, the first fixing member 331 and the second fixing member 332 may approach the battery cell 1 from a side of the battery cell 1 and then move in a direction close to each other with the sealing part 30 of the battery cell 1 therebetween. Thus, the sealing part 30 may be fixed between the first fixing member 331 and the second fixing member 332.

For this, the measurement unit 300 may include an elevation device 340 that elevates the first and second fixing members 331 and 332 and a second moving device 350 that moves the first and second fixing members 331 and 332 in the full-length direction of the battery cell 1.

Each of the elevation device 340 and the second moving device 350 may include an actuator (e.g., a motor). The elevation device 340 is provided in a pair of elements, which operate independently of each other and are respectively connected to the first fixing member 331 and the second fixing member 332, and the second moving device 350 may be connected to the elevation device 340.

An opening 330a for revealing at least a portion of the fixing member 330 and the sealing part 30 with respect to the first confocal-sensor 311 and the second confocal-sensor 312 may be formed. In more detail, an opening 330a that reveals at least a portion of the sealing part 30, at which the thickness is measured, with respect to the first confocal-sensor 311 and the second confocal-sensor 312 may be formed in each of the first fixing member 331 and the second fixing member 332.

In more detail, at least one opening 330a that reveals the plurality of points P1, P2, and P3, at which the thicknesses are measured, with respect to the first confocal-sensor 311 and the second confocal-sensor may be formed in each of the first fixing member 331 and the second fixing member 332.

The opening 330a may have a groove shape that is recessed outward from an inner surface of the fixing member 330.

The first confocal-sensor 311 may be disposed above the first fixing member 331 to measure the distance Dl up to the top surface of the sealing part 30 through the opening 330a formed in the first fixing member 331.

The second confocal-sensor 312 may be disposed below the second fixing member 332 to measure the distance D2 up to the bottom surface of the sealing part 30 through the opening 330a formed in the second fixing member 332.

Even in the state in which the fixing member 330 fixes the sealing part 30, the confocal-sensors 311 and 312 may accurately measure the thickness of the sealing part 30 by the opening 330a.

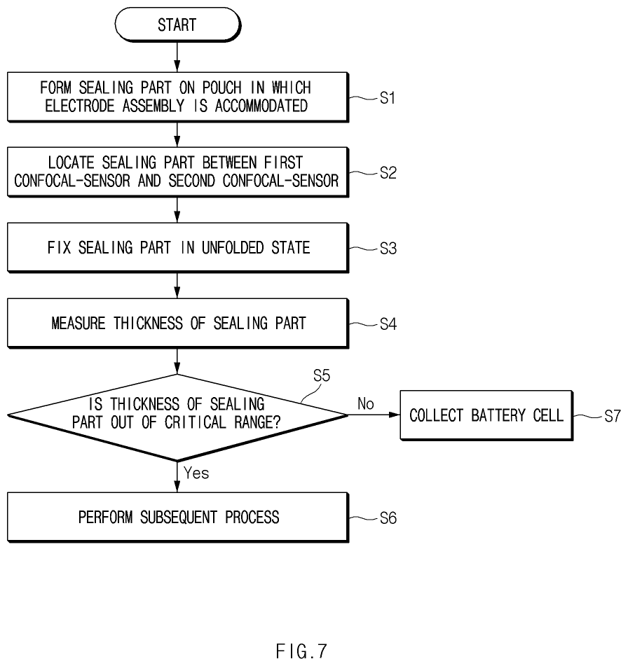

FIG. 7 is a flowchart: illustrating a method for manufacturing a battery cell according to an embodiment of the present invention.

A method for manufacturing a battery cell according to the present embodiment may include a sealing process (S1), a transfer process (S2), a measurement process (S4), and a determination process (S5). The method for manufacturing the battery cell may further include a fixing process (S3).

In the sealing process (S1), a sealing unit 100 may manufacture the battery cell 1 by forming a sealing part 30 on a pouch 20 in which an electrode assembly 10 is accommodated.

During the transfer process (S2), a transfer unit 200 transfers the battery cell 1 to position the sealing part 30 between a first confocal-sensor 311 and a second confocal-sensor 312.

In the fixing process (S3), a fixing member 330 of a measurement unit 300 may fix the sealing part 30 in an unfolded state.

In more detail, in the state in which the sealing part 30 is disposed between the first confocal-sensor 311 and the second confocal-sensor 312, an operation of the transfer unit 200 may be temporarily stopped. In addition, a first fixing member 331 and a second fixing member 332 may move toward the sealing part 30 from a side of the battery cell 1 and be disposed to face each other with the sealing part 30 therebetween. Thereafter, the first fixing member 331 and the second fixing member 332 may be elevated to be close to each other so that the sealing part 30 is fixed between the first fixing member 331 and the second fixing member 332.

In the measurement process (S4), the confocal-sensors 311 and 312 of the measurement unit 300 may measure a thickness of the sealing part 30.

In more detail, the first confocal-sensor 311 may measure a first distance D1 through an opening 330a formed in the first fixing member 331, and the second confocal-sensor 312 may measure a second distance D2 through an opening 330a formed in the second fixing member 332 to calculate the thickness of the sealing part 30 by using the first distance D1 and the second distance D2.

In addition, the confocal-sensors 311 and 312 may move in a longitudinal direction of the sealing part 30 to continuously or discontinuously measure the thickness of the sealing part 30. In more detail, the confocal-sensors 311 and 312 move in the longitudinal direction of the sealing part 30 to sequentially measure thicknesses t1, t2, and t3 at a plurality of points P1, P2, and P3 different from each other. At least one of the plurality of points P1, P2, and P3 may be disposed to correspond to an electrode lead 12.

In addition, each of the first confocal-sensor 311 and the second confocal-sensor 312 may be provided in a pair, and thicknesses of the pair of sealing parts 30 disposed at sides opposite to each other with the cup part 24 therebetween may be measured at the same time.

In addition, thickness data of the sealing part 30 may be stored in a storage 700.

During the determination process (S5), a controller 600 may determine that, if the thickness of the sealing part 30 measured through the measurement process (S4) is within a critical range, the battery cell 1 is normal, and if the thickness of the sealing part 30 is out of the critical range, the battery cell 1 is defective.

In more detail, for one battery cell 1, when the thickness of the sealing part 30 is within the critical range, a discharge unit 400 discharges the one battery cell 1 to a subsequent process line (S6), and when the thickness of the sealing part 30 is out of the critical range, a collection unit 500 may collect the one battery cell 1 (S7).

The critical range is preferably derived based on a plurality of pieces of thickness data collected in the storage 700 for a sample group constituted by a plurality of battery cells 1. On the other hand, it is also possible that the critical range is a preset range.

Thus, it is possible to totally inspect the battery cell 1 and measure the thickness of the sealing part 30 more accurately.

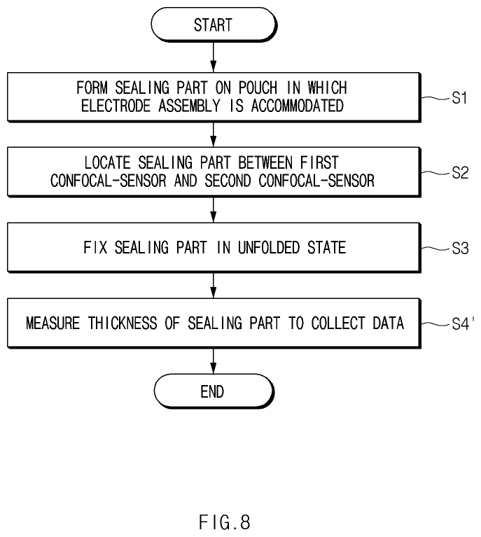

FIG. 8 is a flowchart illustrating a method for manufacturing a battery cell according to another embodiment of the present invention.

A method for manufacturing a battery cell according to the present embodiment may include a sealing process (S1), a transfer process (S2), and a measurement process (S4′). The method for manufacturing the battery cell may further include a fixing process (S3).

Contents of the sealing process (S1), the transferring process (S2), the fixing process (S3), and the measurement process (S4′) will be cited from the contents described above.

Additionally, the thickness of the sealing part 30 measured in the measuring process (S4′) may be stored in a storage 700 to collect thickness data, and thus, a separate determination process may not be performed. Thus, the manufacturing system according to the present embodiment may not include a collection unit 500.

That is, the measuring process (S4′) according to this embodiment is not for determining whether the battery cell 1 is defective, but for collecting the thickness data of the sealing part 30 by totally inspecting the plurality of battery cells 1.

Therefore, there is an advantage in that all the battery cells 1 manufactured by the manufacturing system may be measured and their corresponding data stored.

In addition, a critical range may be set based on a plurality of pieces of thickness data collected in the storage 700 to perform the method of manufacturing the battery cell according to the foregoing embodiment in the future.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present invention is to be considered illustrative, and not restrictive, and the technical spirit of the present invention is not limited to the foregoing embodiment.

Therefore, the scope of the present disclosure is defined not by the detailed description of the invention but by the appended claims, and all differences within the scope will be construed as being included in the present disclosure.

[Description of the Symbols]

| | |
|---|---|
| 1: Battery cell | 10: Electrode assembly |
| 12: Electrode lead | 20: Pouch |
| 24: Cup part | 25: Terrace |
| 26: Side | 27: Expansion part |
| 30: Sealing part | 100: Sealing unit |
| 200: Transfer unit | 300: Measurement unit |
| 311: First confocal-sensor | 312: Second confocal-sensor |
| 320: First moving device | 330: Fixing member |
| 330a: Opening | 331: First fixing member |
| 332: Second fixing member | 340: Elevation device |
| 350: Second moving device | 400: Discharge unit |
| 500: Collection unit | 600: Controller |
| 700: Storage | |

1. A method for manufacturing a battery cell, the method comprising:
forming a sealing part on the battery cell having an electrode assembly accommodated in a pouch;
transferring the battery cell to position the sealing part between a first confocal-sensor and a second confocal-sensor, which are disposed to face each other; and
measuring a thickness of the sealing part with the first confocal-sensor and the second confocal-sensor.

2. The method of claim 1, further comprising fixing the sealing part in an unfolded state, which is performed between the transferring step and the measuring step.

3. The method of claim 1, wherein, in the measuring step, the first confocal-sensor and the second confocal-sensor continuously or discontinuously measure the thickness of the sealing part while the battery cell is moving in a longitudinal direction of the sealing part.

4. The method of claim 1, wherein, in the measuring step, the first confocal-sensor and the second confocal-sensor sequentially measure thicknesses at a plurality of points different from each other while the battery cell is moving in a longitudinal direction of the sealing part.

5. The method of claim 4, wherein at least one of the plurality of points is in a position corresponding to an electrode lead.

6. The method of claim 1, wherein each of the first confocal-sensor and the second confocal-sensor is provided in a pair to simultaneously measure thicknesses of a pair of sealing parts disposed at sides opposite to each other with the electrode assembly therebetween.

7. The method of claim 1, further comprising determining that a battery cell is defective when the thickness of the sealing part, which is measured in the measuring step, in the defective battery cell is out of a critical range.

8. The method of claim 7, wherein the critical range is derived based on a plurality of pieces of thickness data collected through the measuring step for a sample group constituted by a plurality of battery cells.

9. A system for manufacturing a battery cell, the system comprising:
a sealing unit configured to form a sealing part on the battery cell having an electrode assembly accommodated in a pouch;
a measurement unit comprising a first confocal-sensor and a second confocal-sensor, which are disposed to face each other;
a transfer unit configured to transfer the battery cell so that the sealing part is disposed between the first confocal-sensor and the second confocal-sensor; and
a controller configured to calculate a thickness of the sealing part based on a distance from the first confocal-sensor to a first surface of the sealing part and a distance from the second confocal-sensor to a second surface of the sealing part.

10. The system of claim 9, further comprising a discharge unit configured to discharge the battery cell, in which the thickness of the sealing part is completely measured, to a subsequent process line,
wherein the subsequent process line comprises a process of injecting an electrolyte into the battery cell.

11. The system of claim 9, wherein the measurement unit further comprises a fixing member configured to fix the sealing part in an unfolded state.

12. The system of claim 11, wherein an opening configured to reveal at least a portion of the sealing part with respect to the first confocal-sensor and the second confocal-sensor is formed in the fixing member.

13. The system of claim 9, wherein the measurement unit further comprises a moving device configured to move the first confocal-sensor and the second confocal-sensor in parallel to a longitudinal direction of the sealing part, and
the first confocal-sensor and the second confocal-sensor are moved by the moving device to continuously or discontinuously measure the thickness of the sealing part in the longitudinal direction of the sealing part.

14. The system of claim 13, wherein the measurement unit further comprises a fixing member configured to fix the sealing part in an unfolded state, and
at least one opening configured to reveal at least a portion of the sealing part with respect to the first confocal-sensor and the second confocal-sensor is formed in the fixing member.

15. The system of claim 9, wherein the measurement unit further comprises a moving device configured to move the first confocal-sensor and the second confocal-sensor in parallel to a longitudinal direction of the sealing part, and
the first confocal-sensor and the second confocal-sensor area moved by the moving device to sequentially measure thicknesses at a plurality of points different from each other in the longitudinal direction of the sealing part.

16. The system of claim 15, wherein the measurement unit further comprises a fixing member configured to fix the sealing part in an unfolded state, and
at least one opening configured to reveal a plurality of points with respect to the first confocal-sensor and the second confocal-sensor is formed in the fixing member.

17. The system of claim 9, further comprising a storage configured to store thickness data calculated in the controller,
wherein the controller is configured to:
derive a critical range based on a plurality of pieces of thickness data stored in the storage for a sample group constituted by a plurality of secondary batteries; and
determine that a battery is defective when the thickness of the sealing part is out of the critical range in the battery.

18. The system of claim 9, wherein each of the first confocal-sensor and the second confocal-sensor is provided in a pair to measure thicknesses of a pair of sealing parts disposed at sides opposite to each other with the electrode assembly therebetween.
